(19) United States
(12) Patent Application Publication
(10) Pub. No.: US 2026/0071075 A1
(43) Pub. Date: Mar. 12, 2026

(54) PURIFICATION METHOD OF NANOPARTICLE, NANOPARTICLE COMPOSITION, AND MANUFACTURING METHOD OF NANOPARTICLE COMPOSITION

(71) Applicant: CANON KABUSHIKI KAISHA, Tokyo (JP)

(72) Inventors: YUTAKA YOSHIMASA, Kanagawa (JP); YOSHIHIRO OHASHI, Tokyo (JP)

(21) Appl. No.: 19/392,914

(22) Filed: Nov. 18, 2025

Related U.S. Application Data
(63) Continuation of application No. PCT/JP2024/017359, filed on May 10, 2024.

(30) Foreign Application Priority Data
May 19, 2023 (JP) 2023-083370

(51) Int. Cl. C09C 3/10; B82Y 20/00; B82Y 40/00; C09C 1/14; C09K 11/02; C09K 11/66

(52) U.S. Cl. CPC C09C 3/10; C09C 1/14; C09K 11/025; C09K 11/665; B82Y 20/00; B82Y 40/00; C01P 2002/34; C01P 2004/64; C01P 2006/60

(57) ABSTRACT

A method includes a step of preparing a nanoparticle that has a perovskite-type crystal structure as an allotrope and includes multiple crystal structures, a step of preparing a ligand solution containing a solvent that has a relative dielectric constant of a prescribed value or less and an associative ligand that includes a main chain having a plurality of carbon atoms and a polar group having a higher polarity than the main chain and self-associates in the solvent, and a step of preparing a nanoparticle dispersion by bringing the nanoparticle and the ligand solution into contact with each other, wherein the step of preparing a nanoparticle dispersion includes a step of selectively increasing the ratio of the content of a prescribed crystal structure in the multiple crystal structures.

### CROSS-REFERENCE TO RELATED APPLICATIONS

This application is a Continuation of International Patent Application No. PCT/JP2024/017359, filed May 10, 2024, which claims the benefit of Japanese Patent Application No. 2023-083370, filed May 19, 2023, both of which are hereby incorporated by reference herein in their entirety.

### BACKGROUND

### Field of the Technology

The present disclosure relates to a purification method for a nanoparticle, a nanoparticle composition, and a manufacturing method for a nanoparticle composition.

### Description of the Related Art

It is known that a quantum dot having a perovskite-type crystal structure has a narrow full width at half maximum in the spectral sensitivity characteristics and exhibits a high color purity and is therefore applied to organic EL materials, quantum dot light-emitting materials, and solar battery materials. In addition, since the absorption and emission wavelength can be controlled by the composition of halogens, there is an advantage that a material that responds to light over a wide wavelength range can be easily provided.

It is known that a quantum dot having a perovskite-type crystal structure has a variety of crystalline phases depending on the synthesis conditions and storage conditions (Phys. Rev. Materials, 3, 113605). Light-emitting characteristics and power generation characteristics are highly affected by the type of the crystalline phase. The phase that exhibits the best characteristic is the α-phase, but the α-phase is a high-temperature stable phase, and it is therefore difficult to selectively produce the α-phase by a usual synthesis method.

In Angew. Chem. Int., Ed. 2018, 57, 9083-9087, a quantum dot having an α-phase is obtained by synthesizing the quantum dot at a high temperature condition of 260° C. while reacting oleylamine hydroiodide.

However, the synthesis method described in Angew. Chem. Int., Ed. 2018, 57, 9083-9087 requires a high temperature condition of 260° C. and has been therefore suppressed from industrial application. In addition, the quantum dot obtained by the synthesis method described in Angew. Chem. Int., Ed. 2018, 57, 9083-9087 has a problem that the crystalline phase changes gradually from the α-phase to another with time.

### SUMMARY

The present invention has been made in view of the above problem and aims to provide a method of purifying a nanoparticle that can obtain an α-phase at a lower temperature condition. In addition, the present invention aims to provide a nanoparticle composition that can maintain the α-phase even over time.

The method of purifying a nanoparticle according to an embodiment of the present invention includes a step of preparing a nanoparticle that has a perovskite-type crystal structure as an allotrope and includes multiple crystal structures, a step of preparing a ligand solution containing a solvent that has a relative dielectric constant of a prescribed value or less and an associative ligand that includes a main chain having a plurality of carbon atoms and a polar group having a higher polarity than the main chain and self-associating in the solvent, and a step of preparing a nanoparticle dispersion by bringing the nanoparticle and the ligand solution into contact with each other, wherein the step of preparing the nanoparticle dispersion includes a step of selectively increasing the ratio of the content of a prescribed crystal structure in the multiple crystal structures.

The method of manufacturing a nanoparticle composition according to an embodiment of the present invention includes a step of preparing a nanoparticle that has a perovskite-type crystal structure as an allotrope and includes multiple crystal structures, a step of preparing a ligand solution containing a solvent that has a relative dielectric constant of a prescribed value or less and an associative ligand that includes a main chain having a plurality of carbon atoms and a polar group having a higher polarity than the main chain and self-associating in the solvent, and a step of preparing a nanoparticle dispersion by bringing the nanoparticle and the ligand solution into contact with each other, wherein the step of preparing the nanoparticle dispersion includes a step of selectively increasing the ratio of the content of a prescribed crystal structure in the multiple crystal structures.

The nanoparticle composition according to an embodiment of the present invention includes a nanoparticle having a perovskite-type crystal structure as an allotrope and an associative ligand including a main chain having a plurality of carbon atoms and a polar group having a higher polarity than the main chain, wherein at least a portion of the associative ligand coordinates to the nanoparticle via the polar group to change the crystal structure of the nanoparticle.

The nanoparticle composition according to an embodiment of the present invention includes a solvent having a relative dielectric constant of a prescribed value or less, a nanoparticle having a perovskite-type crystal structure as an allotrope, and multiple ligands each including a main chain having a plurality of carbon atoms and a polar group having a higher polarity than the main chain, wherein the multiple ligands include a first component that constitutes a reverse micelle-like structure in the solvent and a second component that coordinates to the surface of the nanoparticle.

Features of the present disclosure will become apparent from the following description of embodiments with reference to the attached drawings.

### BRIEF DESCRIPTION OF THE DRAWINGS

FIG. 1A is a flow chart of a method of manufacturing a nanoparticle composition according to a first embodiment.

FIG. 1B is a flow chart of a method of purifying a nanoparticle according to the first embodiment.

FIG. 2A is a diagram schematically illustrating the structures of nanoparticles P and ligand solutions Q (60-1 to 60-4) according to the first embodiment.

FIG. 2B is a diagram schematically illustrating the structures of ligand solutions Q (60-1 and 60-2) according to the first embodiment.

FIG. 2C is a diagram schematically illustrating the structure of a ligand solution Q (60-3) according to the first embodiment.

FIG. 2D is a diagram schematically illustrating the structure of a ligand solution Q (60-4) according to the first embodiment.

FIG. 3A is a diagram schematically illustrating the structure of a nanoparticle composition according to a second embodiment.

FIG. 3B is a diagram schematically illustrating the structure of a nanoparticle composition according to the second embodiment.

FIG. 4A is a diagram schematically illustrating the structure of a nanoparticle composition according to a third embodiment.

FIG. 4B is a diagram schematically illustrating the structure of a nanoparticle composition according to the third embodiment.

FIG. 5 is a diagram schematically illustrating a wavelength conversion layer containing a nanoparticle composition and a display device according to a fourth embodiment.

### DESCRIPTION OF THE EMBODIMENTS

Preferred embodiments of the present invention will now be described in detail using the drawings. The dimensions, materials, shapes, relative arrangements, and so on of the components described in these embodiments are not intended to limit the scope of this invention.

### First Embodiment

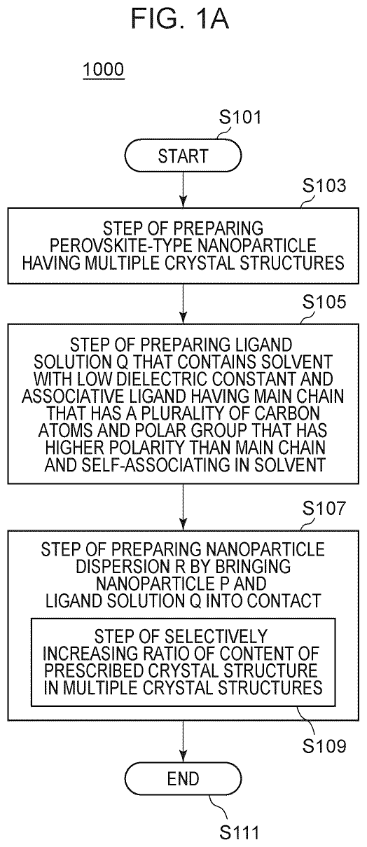

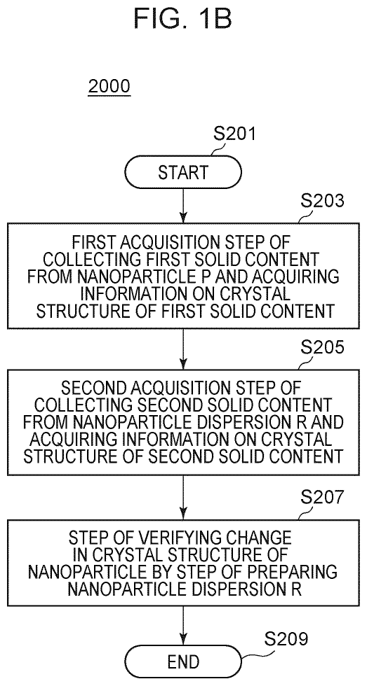

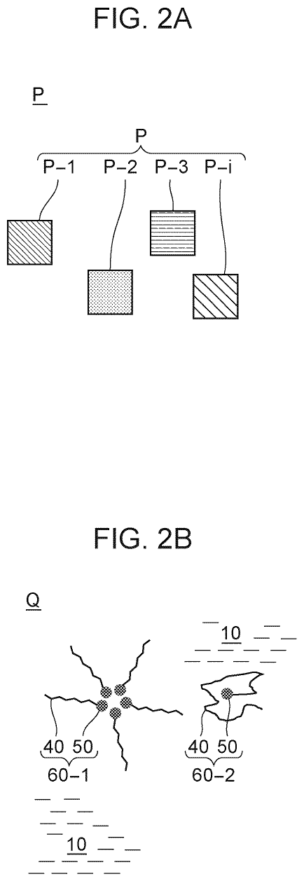

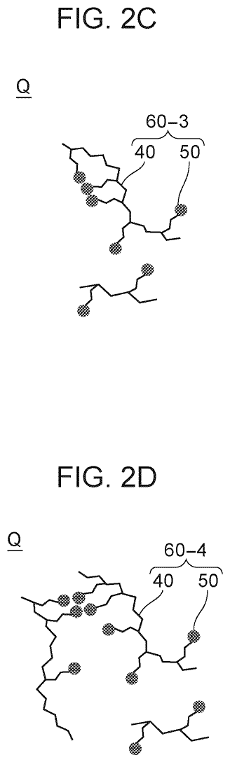

A manufacturing method and constitution of the nanoparticle composition according to a first embodiment and a purification method of the nanoparticle will be described using FIG. 1A, FIG. 1B, and FIGS. 2A to 2D.

The manufacturing method 1000 of a nanoparticle composition according to the first embodiment at least includes steps of S103, S105, S107, and S109 between START step S101 and END step S111 as is shown in FIG. 1A.

### S103

The step S103 is a step of preparing a nanoparticle A having a perovskite-type crystal structure as an allotrope and including multiple crystal structures.

### S105

The step S105 is a step of preparing a ligand solution B that contains a solvent 10 having a relative dielectric constant of a prescribed value or less and an associative ligand 60 that has a main chain 40 having a plurality of carbon atoms and a polar group 50 having a higher polarity than the main chain 40 and self-associates in the solvent 10.

### S107, S109

The step S107 is a step of preparing a nanoparticle dispersion C by bringing a nanoparticle P and a ligand solution Q into contact with each other and includes a step S109 of selectively increasing the ratio of the content of a prescribed crystal structure in multiple crystal structures.

The manufacturing method 1000 of a nanoparticle composition according to the present embodiment includes the step S109 of selectively increasing the content ratio of a prescribed crystal structure corresponding to the nanoparticle P in multiple crystal structures and may be therefore rephrased as a purification method 1000 of a nanoparticle.

In the manufacturing method 1000 of a nanoparticle composition, regarding the mechanism of selectively increasing the content ratio of a prescribed crystal structure, the present inventors consider as follows.

Firstly, it is premised that since a nanoparticle P having a perovskite-type crystal structure as an allotrope is unstable against polar materials, when the nanoparticle P is dispersed and supported in a solvent, it is necessary to disperse the nanoparticle P in a solvent having a relative dielectric constant of a prescribed value or less (low polar solvent).

Secondly, in order to protect the nanoparticle P having a perovskite-type crystal structure as an allotrope, it is considered a case of coordinating a ligand having a polar group to the surface of the nanoparticle P.

Since the ligand including a polar group has low affinity to low polar solvents, it is impossible to allow a large amount of the ligand to act on the nanoparticle P. In contrast, the associative ligand 60 exhibiting self-association in relation to a solvent decreases the apparent polarity when the polar groups 50 associate with each other and allows the polar portion to be present at a high concentration even in a low polar solvent (ligand solution Q). In the present specification, self-association of a ligand means a property to take the form of a reverse micelle-like structure with non-polar groups facing the solvent side by at least any of association of a single ligand itself and association of a plurality of related ligands.

When the ligand solution Q and the nanoparticle P are brought into contact with each other, a component 60-a in which at least a portion of the self-associated associative ligand 60 is dissociated and a component 60-b in which the self-association is maintained are generated in the solvent 10. It is inferred that the dissociated ligand 60-a of the associative ligand 60 coordinates to the surface of the nanoparticle P. It may be rephrased that at least a portion of the nanoparticle P is protected so as to be incorporated in an associated portion of the associative ligand 60. A plurality of polar groups 50 of the associative ligand 60 coordinate to the surface of the nanoparticle P all at once. The present inventors infer that a change to an α-phase, which is a high-temperature stable phase, is induced by using this sharp coordination as a driving force.

### Self-Association

In the present embodiment, the self-association means association by electrostatic interaction of at least a portion of polar groups 50 in the solvent 10 having a relative dielectric constant of a prescribed value or less. The polar groups 50 do not necessarily have to directly interact with each other, and a small amount of a polar material, such as water, may intervene therebetween. In addition, the self-association may be intermolecular association (60-1) or intramolecular association (60-2) as are shown in FIG. 2B. Furthermore, even when different types of polar groups associate with each other by electrostatic interaction and constitute a reverse micelle-like structure with respect to a common solvent 10, it is regarded as self-association.

### Nanoparticle

The nanoparticle P in the present embodiment is a nanoparticle that includes, as an allotrope, a nanocrystal having a perovskite-type crystal structure in which an A-site (monovalent cation), a B-site (divalent cation), and an X-site (monovalent anion including a halide anion) as structural components. The perovskite-type crystal structure is rephased as a perovskite-type structure, an ABX₃-type crystal structure, or an ABX₃-type structure. In addition, a double perovskite-type crystal structure represented by A₂B₁B₂X₆ is also included in the perovskite-type crystal structure. In the present specification, the nanoparticle P may be rephrased as a light-emitting nanoparticle, a light-emitting nanocrystal, a photoresponsive nanocrystal, or a quantum dot.

The particle size of the nanoparticle is preferably 1 nm or more and 30 nm or less and more preferably 2 nm or more and 25 nm or less as the average particle size of the nanoparticle. If the average particle size is less than 1 nm, the stability may be insufficient. If the average particle size is larger than 30 nm, the dispersibility in a medium may be insufficient.

### A-Site of Perovskite-Type Structure

As the A-site, a monovalent cation is adopted. Examples of the monovalent cation used in the A-site include nitrogen-containing organic compound cations, such as an ammonium cation (NH₄⁺), an alkyl ammonium cation having 6 or less carbon atoms, a formamidinium cation (HC(NH₂)₂⁺), a guanidinium cation (C(NH₂)₃⁺), an imidazolium cation, a pyridinium cation, and a pyrrolidinium cation and include alkali metal cations, such as a lithium cation (Li⁺), a sodium cation (Na⁺), a potassium cation (K⁺), a rubidium cation (Rb⁺), and a cesium cation (Cs⁺).

These monovalent cations adopted in the A-site have small ion diameters and have sizes enough to fit into the crystal lattice, and therefore the perovskite compound can form a stable three-dimensional crystal.

Preferable examples of the alkyl ammonium cation having 6 or less carbon atoms include a methyl ammonium cation (CH₃NH₃⁺), an ethyl ammonium cation (C₂H₅NH₃⁺), and a propyl ammonium cation (C₃H₇NH₃⁺.

From the viewpoint of obtaining a high emission efficiency, at least any of a methyl ammonium cation, a formamidinium cation, and a cesium cation is preferably used as the A-site, and from the viewpoint of suppressing a change in the color, the A-site is more preferably a cesium cation. These monovalent cations may be used in the A-site in combination of two or more.

When the A-site is a cesium cation, a cesium salt is used as a raw material for synthesis of the nanoparticle. As the cesium salt, cesium chloride, cesium bromide, cesium iodide, cesium hydroxide, cesium carbonate, cesium hydrogen carbonate, cesium bicarbonate, cesium formate, cesium acetate, cesium propionate, cesium pivalate, or cesium oxalate is suitably used. An appropriate cesium salt among these cesium salt candidates can be used depending on the synthesis method.

When the A-site is another alkali metal cation, for example, a salt obtained by substituting the cesium element of the above-mentioned cesium compound with another alkali metal cation element can be used as a raw material.

When the A-site is a nitrogen-containing compound cation such as a methyl ammonium cation, for example, a neutral compound other than a salt, such as methylamine, can be used as a raw material. These raw materials may be used in combination of two or more.

### Perovskite-Type Crystal Structure B-Site

As the B-site of the perovskite-type crystal structure, a divalent transition metal cation or a divalent cation including a typical divalent metal cation is adopted.

As the divalent transition metal cation, a scandium cation (Sc²⁺), a titanium cation (Ti²⁺), a vanadium cation (V²⁺), a chromium cation (Cr²⁺), a manganese cation (Mn²⁺), an iron cation (Fe²⁺), a cobalt cation (Co²⁺), a nickel cation (Ni²⁺), a copper cation (Cu²⁺), a palladium cation (Pd²⁺), a europium cation (Eu²⁺), or an ytterbium cation (Yb²⁺) is adopted.

As the typical divalent metal cation, a magnesium cation (Mg²⁺), a calcium cation (Ca²⁺), a strontium cation (Sr²⁺), a barium cation (Ba²⁺), a zinc cation (Zn²⁺), a cadmium cation (Cd²⁺), a germanium cation (Ge²⁺), a tin cation (Sn²⁺), or a lead cation (Pb²⁺) can be adopted.

Among these divalent cations, in terms of making a stable three-dimensional crystal grow, a typical divalent metal cation is preferable, and a tin cation or a lead cation is more preferable, and from the viewpoint of obtaining a high emission intensity, a lead cation is particularly preferable. These divalent cations may be used in combination of two or more, and the perovskite-type crystal structure may be a so-called double perovskite type.

When the B-site is a lead cation, a lead compound is used as a raw material for synthesis of the nanoparticle, an appropriate lead compound can be used depending on the synthesis method. As the lead compound, lead chloride, lead bromide, lead iodide, lead oxide, lead hydroxide, lead sulfide, lead carbonate, lead formate, lead acetate, lead 2-ethylhexanoate, lead oleate, lead stearate, lead naphthenate, lead citrate, lead maleate, or lead acetylacetonate is adopted. When the B-site is another divalent metal cation, a salt obtained by substituting the lead element of the above-mentioned lead compounds with another divalent metal cation element can be used as a raw material. These raw materials may be used in combination of two or more.

### X-Site of Perovskite-Type Crystal Structure

As the X of the perovskite-type crystal structure, a monovalent anion including a halide anion is adopted. Examples of the halide anion include a fluoride anion (F⁻), a chloride anion (Cl⁻), a bromide anion (Br⁻), and an iodide anion (I⁻). In particular, a chloride anion, a bromide anion, and an iodide anion are preferable from the viewpoint of forming a stable three-dimensional crystal and showing strong light emission in the visible light region. The emission color is blue when a chloride anion is used, green when a bromide anion is used, and red when an iodide anion is used.

Two or more types of halide anions may be used. In particular, when a chloride anion, a bromide anion, and an iodide anion are used in combination, the emission wavelength of the nanoparticle can be adjusted to a desired wavelength depending on the content ratio of the anion species. That is, in particular, a combination use of a chloride anion, a bromide anion, and an iodide anion is preferable because a light emission spectrum that covers almost all region of the visible light from blue to red can be obtained while maintaining a narrow full width at half maximum depending on the content ratio of the anion species.

The X-site may include a monovalent anion other than halide anions. Examples of the monovalent anion other than halide anions include pseudo-halide anions such as a cyanide anion (CN⁻), a thiocyanate anion (SCN⁻), and an isothiocyanate anion (CNS⁻). The raw material for nanoparticle synthesis can be appropriately selected from a salt with counter cations at the A-site and the B-site, such as cesium chloride and lead bromide, and a salt with a cation other than the above depending on the synthesis method.

The nanoparticle P in the present embodiment can be manufactured by a process as follows. For example, a hot injection method of obtaining a stable product by mixing a raw material solution at high temperature to generate a microparticle and then rapidly cooling it or a ligand-assisted reprecipitation method of obtaining a microparticle by reprecipitation utilizing a difference in the miscibility of the product with a solvent is adopted.

In addition, a room temperature synthesis method of obtaining a microparticle by mixing a mixture solution of a raw material for an A-site and a raw material for a B-site that are non-halides not containing a component for an X-site with a separately prepared raw material solution of an X-site under a moderate condition of around room temperature is also a manufacturing method to be adopted. Furthermore, a mechanochemical method of obtaining a product microparticle by reaction through mechanical mixing, such as milling, or ultrasonication of a solid raw material and an in situ synthesis method of obtaining a reaction product by applying a raw material solution onto a substrate and then performing direct crystal growth are also manufacturing methods to be adopted.

A ligand described later is coordinated to the surface of the nanoparticle P by coexistence during manufacturing of the nanoparticle P, and the dispersion can be stabilized.

### Solvent

As the solvent, a low polar solvent having a relative dielectric constant of a prescribed value or less (low relative dielectric constant solvent) can be used. The prescribed value is 6.0 or less and more preferably 4.5 or less.

Specific examples thereof include an aromatic hydrocarbon, such as xylene (relative dielectric constant: 2.3) and toluene (relative dielectric constant: 2.4); a hydrocarbon, such as hexane (relative dielectric constant: 1.9); an alicyclic hydrocarbon, such as cyclohexane (relative dielectric constant: 2.0); an ester, such as ethyl acetate (relative dielectric constant: 6.0) and butyl acetate (relative dielectric constant: 5.0); a halogenated alkyl, such as chloroform (relative dielectric constant: 4.9); and an ether, such as diethyl ether (relative dielectric constant: 4.3). As needed, these solvents can also be used as a mixture. In such a case, the relative dielectric constant is the weighted average of all solvents.

### Ligand

In the present embodiment, the ligand 60 is preferably at least one compound or ion selected from the group consisting of a weak acid such as carboxylic acid, a weak base such as amine, and salts and ions thereof.

Examples of the acid include branched or linear fatty acids having 1 to 30 carbon atoms. The alkyl chain may be saturated or unsaturated. In particular, from the viewpoint of solubility and stability to a solvent, a linear fatty acid is preferable, and oleic acid is further preferable.

Examples of the base include branched or linear organic bases having 1 to 30 carbon atoms. The alkyl chain may be saturated or unsaturated. In particular, from the viewpoint of solubility and stability to a solvent, a linear organic base is preferable, and oleylamine is further preferable.

The ligand 60 may consist of a single ligand or a combination of two or more ligands.

### Amount of Ligand Relative to Nanoparticle P

The amount of the ligand is preferably 10 or more and 500 or less when the nanoparticle P is 100, more preferably 20 or more and 400 or less and further preferably 30 or more and 300 or less. When the amount of the ligand is less than 10 or greater than 300, the dispersion stability of the nanoparticle P may be insufficient.

### Associative Ligand

In the present embodiment, the associative ligand 60 includes a main chain 40 having a plurality of carbon atoms and a polar group 50 having a higher polarity than the main chain 40, and includes an associative ligand that self-associates in a solvent 10. The associative ligand 60 may be constituted of a low molecular compound as is shown in FIG. 2B or may be constituted of a high molecular compound as is shown in FIG. 2C. Alternatively, both a low molecular compound and a high molecular compound may be included (not shown). As is shown in FIG. 2C, the self-association may occur intramolecularly, or as is shown in FIG. 2D, the self-association may occur intermolecularly. In FIG. 2B, the main chain 40 of the ligand 60 is linear, but the main chain 40 may be a branched skeleton.

From the viewpoint of more effectively inducing a change to an α-phase, the associative ligand 60 is preferably mainly constituted of a high molecular compound.

The main chain 40 of the low molecular compound is a linear, branched, or cyclic alkyl group, a linear, branched, or cyclic heteroalkyl group, an aryl group, a heteroaryl group, an aralkyl group, or a heteroaralkyl group. These compounds may be further partially substituted.

The polar group 50 is constituted of a strong acid such as sulfonic acid and phosphonic acid, a strong base such as a quaternary ammonium cation, or a zwitterion group such as sulfobetaine, phosphobetaine, and carboxybetaine. The polar group 50 may take the form of at least one compound or ion selected from the group consisting of the above-mentioned salts and ions as the components.

As the high molecular compound, a copolymer (described later) obtained by polymerizing at least two types of monomers can be used.

### Amount of Associative Ligand Relative to Nanoparticle P

The amount of the associative ligand is preferably 1 or more and 1000 or less when the nanoparticle P is 100, more preferably 10 or more and 800 or less and further preferably 30 or more and 600 or less. When the amount of the associative ligand is less than 10, the effect of single phase formation may not be sufficiently obtained. When the amount of the associative ligand is larger than 600, the associated product of the associative ligand may not be well formed in the solvent.

### Millimolar Number of Polar Group Per 1 g of Nanoparticle P

The millimolar number of the polar group per 1 g of the nanoparticle P is preferably 0.01 to 10, preferably 0.03 to 8, and more preferably 0.1 to 6. When the millimolar number of the polar group per 1 g of the nanoparticle P is within the above range, coordination to the nanoparticle P progresses all at once, and formation of a single crystalline phase easily progresses. When the millimolar number is less than 0.01, formation of a single crystalline phase may not sufficiently progress. When the millimolar number is greater than 10, the associated product may not be well formed in a low polar solvent. The millimolar number corresponds to the content of the polar group included in 1 g of the nanoparticle P and is a unit corresponding to ×10³ mol.

### Method for Manufacturing Nanoparticle Composition

The purification method of the nanoparticle of the present invention will be described in detail below.

The purification method of the present invention includes the following steps:
a step of preparing a nanoparticle (A) having a perovskite-type crystal structure as an allotrope and including multiple crystal structures;
a step of preparing a ligand solution (B) including a solvent that has a relative dielectric constant of a prescribed value or less and an associative ligand that includes a main chain having a plurality of carbon atoms and a polar group having a higher polarity than the main chain and self-associates in the solvent; and
a step of preparing a nanoparticle dispersion (C) by bringing the nanoparticle P and the ligand solution Q into contact with each other, where the step of preparing a nanoparticle dispersion (C) includes a step of making the crystal structure of the nanoparticle single-phase.

### Step of Preparing Nanoparticle P

The method for preparing the nanoparticle P is as described above. As needed, the surplus ligand may be removed by centrifugation or the like.

### Step of Preparing Ligand Solution Q

In order to prepare the ligand solution Q, the second ligand manufactured by the above-described method may be dispersed in a second solvent 80. As needed, the dispersion can be promoted by ultrasonication, heating, or the like.

### Step of Preparing Nanoparticle Dispersion R

In order to prepare the nanoparticle dispersion R, the nanoparticle P and the ligand solution Q may be mixed. On this occasion, a ligand solution Q may be mixed with a solid nanoparticle P, or a dispersion in which the nanoparticle P is dispersed in a solvent and the ligand solution Q may be mixed. The dispersion solvent of the nanoparticle P may be the same as or different from the solvent of the ligand solution Q. The dispersion solvent of the nanoparticle P preferably has a relative dielectric constant of a prescribed value or less. The prescribed value is preferably 6.0 or less and more preferably 4.5 or less.

### Step of Selectively Increasing Ratio of Content of Prescribed Crystal Structure in Multiple Crystal Structures

In the present embodiment, the step of selectively increasing the ratio of the content of a prescribed crystal structure in the multiple crystal structures preferably includes a step of making the crystal structure of the nanoparticle single-phase. The step of selectively increasing the ratio of the content of a prescribed crystal structure in the multiple crystal structures preferably includes a step of alternatively increasing the ratio of the content of a prescribed crystal structure in the multiple crystal structures. In the purification method 1000 of the nanoparticle, as is shown in FIG. 1B, a verification method 2000 of a crystal structure including the steps S201 to S209 is carried out. A change in the crystal structure of the nanoparticle P by the step of preparing the nanoparticle dispersion R can be verified by carrying out the steps S201 to S209.

### First Acquisition Step S203

The first acquisition step S203 includes a step of collecting a first solid content from the nanoparticle P obtained by the step S103 and acquiring information on the crystal structure of the first solid content. The information on the crystal structure of the first solid content is obtained by analysis such as a diffraction angle spectrum by X-ray diffraction, a halo pattern obtained by electron beam diffraction, or the like.

### Second Acquisition Step S205

The second acquisition step S205 includes a step of collecting a second solid content from the nanoparticle dispersion and acquiring information on the crystal structure of the second solid content. A method similar to the method acquiring information on the crystal structure of the first solid content is adopted as the method for acquiring information on the crystal structure of the second solid content, but the method is preferably the same as the method for acquiring information on the crystal structure of the first solid content.

### Step S207 for Verifying Change in Crystal Structure

The step S207 of verifying the change in the crystal structure verifies the change in the crystal structure of the nanoparticle P due to the step of preparing the nanoparticle dispersion based on the information regarding the crystal structure of the first solid content and the information regarding the crystal structure of the second solid content.

### Multiple Crystal Structures

Next, the multiple crystal structures of the nanoparticle P prepared in the step S103 will be described.

It is preferable that the multiple crystal structures include an α-phase and at least one of a β-phase and a γ-phase and that the prescribed crystal structure includes an α-phase. Here, the α-phase is a crystalline phase classified in a cubic crystal system. The β-phase is a crystalline phase classified in a tetragonal crystal system. The γ-phase is a crystalline phase classified in an orthorhombic crystal (rhombic crystal) system. Among the α-phase, the β-phase, and the γ-phase, the α-phase is the high-temperature stable phase.

The multiple crystal structures include multiple crystal structures of which the synthesis temperatures are different from each other, and the prescribed crystal structure preferably corresponds to the crystal structure having the highest synthesis temperature among the multiple crystal structures.

The multiple crystal structures may be crystal structures such as AB₂X₅ and A₄BX₆.

In the step of making the crystal structure of the nanoparticle single-phase, the formation of a single-phase crystal structure of the nanoparticle is preferably verified by subjecting both the first solid content of the nanoparticle P accumulated on the base material and the second solid content of the nanoparticle dispersion R accumulated on the base material to X-ray diffraction (XRD) measurement. Specifically, the formation of a single-phase crystal structure can be confirmed by that the signals of the β-phase and the γ-phase are changed from two peaks to a single peak or from a broad peak due to overlapping of the peaks to a sharp peak.

The effect of the step of selectively increasing the ratio of the content of the prescribed crystal structure in the multiple crystal structures can be verified by the steps S203 and S205 shown in FIG. 1B.

The first acquisition step S203 includes a step of collecting a first solid content from a part of the nanoparticle P and acquiring information on the crystal structure of the first solid content. The second acquisition step S205 includes a step of collecting a second solid content from a part of the nanoparticle dispersion R and acquiring information on the crystal structure of the second solid content.

The selective increase in the ratio of the content of the prescribed crystal structure in the multiple crystal structures due to the step of preparing a nanoparticle dispersion R can be verified by the verification step S207 based on the information on the crystal structure of the first solid content and the information on the crystal structure of the second solid content.

In order to promote the formation of a single-phase crystal structure, it is preferable to perform heating, ultrasonication, or the like. The heating temperature is preferably 30° C. to 100° C. and more preferably 40° C. to 80° C.

### Method for Manufacturing High Molecular Compound

A method for manufacturing a high molecular compound that can be used as the associative ligand 60 will be described in detail below. The method for manufacturing a high molecular compound is not particularly limited as long as the above-described structure is obtained, but the high molecular compound can be manufactured by, for example, the following method (i) or (ii).

That is, examples of the method (i) for manufacturing a high molecular compound include a manufacturing method by manufacturing a monomer having a structure unit including a polar group and then polymerizing the monomer. Examples of the method (ii) for manufacturing a high molecular compound include a method by synthesizing a polymer main chain and then bonding a polar group to the polymer main chain.

From the viewpoint of availability of a monomer and control of the amount of a functional group, manufacturing by the method (i) is preferable. A method for synthesizing a high molecular compound containing a zwitterion group as the polar group will be described in detail using the method (i) below.

As the monomer for introducing a polar group into a high molecular compound, a vinyl ether derivative, an acrylate derivative, a methacrylate derivative, an α-olefine derivative, an aromatic vinyl derivative, or the like can be used. From the viewpoint of ease of manufacturing of the monomer, it is preferable to use an acrylate derivative or s methacrylate derivative as the monomer.

The corresponding acrylate derivative or methacrylate derivative can be manufactured by, for example, the method described in the following literature: K. Ishihara and two others, “Polymer Journal”, (Japan), The society of Polymer Science, 1990, Vol. 22, pp. 355-360.

Examples of the method for polymerizing the above monomer include radical polymerization and ionic polymerization, and living polymerization for the purpose of molecular weight distribution control and structure control can also be used. Industrially, it is preferable to use radical polymerization.

The radical polymerization can be performed by the use of a radical polymerization initiator, light irradiation of radiation, laser light, and so on, combination use of a photopolymerization initiator and light irradiation, heating, or the like. The radical polymerization initiator may be one that can generate a radical and initiate polymerization and is selected from compounds that generate radicals by the action of heat, light, radiation, redox reaction, and so on.

Examples of the compound include an azo compound, an organic peroxide, an inorganic peroxide, an organic metal compound, and a photopolymerization initiator.

More specific examples include an azo compound, such as 2,2′-azobisisobutyronitrile (AIBN) and 2,2′-azobis(2,4-dimethylvaleronitrile); an organic peroxide, such as benzoyl peroxide (BPO), tert-butyl peroxypivalate, and tert-butylperoxy isopropyl carbonate; an inorganic peroxide, such as potassium persulfate and ammonium persulfate; and a redox initiator, such as a hydrogen peroxide-iron(II) salt system, a BPO-dimethylaniline system, and a cerium(IV) salt-alcohol system. Examples of the photopolymerization initiator include an acetophenone system, a benzoin ether system, and a ketal system. These radical polymerization initiators may be used in combination of two or more.

The preferable range of the polymerization temperature of the vinyl monomer varies depending of the type of the polymerization initiator to be used, and polymerization is usually performed at a temperature of −30° C. to 150° C., and more preferable temperature range is from 40° C. to 120° C.

The amount of the polymerization initiator to be used on this occasion is 0.1 parts by mass or more and 20 parts by mass or less based on 100 parts by mass of the monomer, and is preferably adjusted so as to obtain a high molecular compound with a target molecular weight distribution.

The polymerization method can be any of solution polymerization, suspension polymerization, emulsion polymerization, dispersion polymerization, precipitation polymerization, and bulk polymerization, and is not particularly limited.

The obtained high molecular compound may be purified as needed. The purification method is not particularly limited, and a method such as reprecipitation, dialysis, column chromatography can be used.

The structure of the manufactured high molecular compound can be identified using various equipment analysis. As the analytical equipment, a nuclear magnetic resonance apparatus (NMR), a gel permeation chromatography (GPC), an inductively coupled plasma emission spectrometer (ICP-AES), and so on can be used.

### Polymerizable Compound

The polymerization of the polymerizable compound is promoted by receiving energy such as light and heat, and the compound becomes a component that imparts viscosity to the photoresponsive composition and cures it. As the polymerizable compound, a radical polymerizable compound or a cationic polymerizable compound can be used. These compounds may be used alone or in combination of two or more. Alternatively, a photopolymerizable compound or a thermopolymerizable compound can also be used. In the present specification, a form in which the viscosity is increased by polymerization of the polymerizable compound may be rephrased as a polymer.

As the radical polymerizable compound, for example, a monofunctional (meth)acrylate-based compound, a bifunctional (meth)acrylate-based compound, a tri- or more functional (meth)acrylate-based compound, a hydroxy group-containing (meth)acrylate-based compound, a carboxy group-containing (meth)acrylate-based compound, or a vinyl-based compound can be used.

As the monofunctional (meth)acrylate, for example, methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, cyclohexyl (meth)acrylate, dicyclopentenyl (meth)acrylate, dicyclopentenyloxyethyl (meth)acrylate, benzyl (meth)acrylate, 3,3,5-trimethylcyclohexyl acrylate, tetrahydrofurfuryl (meth)acrylate, phenoxyethyl (meth)acrylate, methoxyethyl (meth)acrylate, ethyl carbitol (meth)acrylate, isobornyl (meth)acrylate, methoxytriethylene glycol (meth)acrylate, (2-methyl-2-ethyl-1,3-dioxolan-4-yl)methyl (meth)acrylate, (3-ethyloxetan-3-yl)methyl (meth)acrylate, or cyclic trimethylolpropane formal (meth)acrylate can be used.

As the bifunctional (meth)acrylate-based compound, for example, 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, triethylene glycol di(meth)acrylate, tetraethylene glycol di(meth)acrylate, polyethylene glycol 200 di(meth)acrylate, polyethylene glycol 300 di(meth)acrylate, polyethylene glycol 400 di(meth)acrylate, polyethylene glycol 600 di(meth)acrylate, dipropylene glycol di(meth)acrylate, tripropylene glycol di(meth)acrylate, tetrapropylene glycol di(meth)acrylate, polypropylene glycol 400 di(meth)acrylate, polypropylene glycol 700 di(meth)acrylate, neopentyl glycol di(meth)acrylate, neopentyl glycol PO-modified di(meth)acrylate, EO-modified bisphenol A di(meth)acrylate, PO-modified bisphenol A di(meth)acrylate, or hydroxypivalic acid neopentyl glycol di(meth)acrylate can be used.

As the tri- or more functional (meth)acrylate-based compound, for example, trimethylolpropane tri(meth)acrylate, trimethylolpropane EO-modified tri(meth)acrylate, trimethylolpropane PO-modified tri(meth)acrylate, glycerin propoxy tri(meth)acrylate, pentaerythritol tri(meth)acrylate, tris(acryloxyethyl) isocyanurate, or EO-modified pentaerythritol tetraacrylate can be used.

As the vinyl-based compound, for example, vinyl acetate, vinyl benzoate, vinyl pivalate, vinyl butyrate, vinyl methacrylate, or N-vinyl pyrrolidone can be used.

As the cationic polymerizable compound, either a photopolymerizable or thermopolymerizable type can be used. These compounds may be used alone or in combination of two or more. Typical examples of the cationic polymerizable compound include an epoxy compound, an oxetane compound, and a vinyl ether compound.

The amount of the polymerizable compound, such as the radical polymerizable compound and the cationic polymerizable compound, to be used is preferably 1 to 99 parts by mass, more preferably 3 to 90 parts by mass, and further preferably 5 to 80 parts by mass based on 100 parts by mass of the total photoresponsive composition.

### Polymerization Initiator

In a polymerization reaction, a polymerization initiator and a polymerizable compound are usually used together. The polymerization initiator is a compound that generates an active species that initiates a polymerization reaction by active energy ray irradiation or heat, and a known polymerization initiator can be used. Main examples of the active species that initiates the polymerization reaction include a radical that is generated by a radical polymerization initiator and acid that is generated by a cationic polymerization initiator, and they may be used in combination. Examples of the photoradical polymerization initiator that generates a radical by an active energy ray include acetophenones, such as diethoxyacetophenone, 2-hydroxy-2-methyl-1-phenylpropan-1-one, benzyl methyl ketal, 4-(2-hydroxyethoxy)phenyl-(2-hydroxy-2-propyl)ketone, 1-hydroxycyclohexylphenyl ketone, 2-methyl-1-[4-(methylthio)phenyl]-2-morpholinopropan-1-one, 2-benzyl-2-dimethylamino-1-(4-morpholinophenyl) butane, oligo[2-hydroxy-2-methyl-1-[4-(1-methylvinyl)phenyl]propanone], and 2-hydroxy-1-[4-[4-(2-hydroxy-2-methylpropionyl)benzyl]phenyl]-2-methylpropan-1-one; benzoins, such as benzoin, benzoin methyl ether, benzoin ethyl ether, benzoin isopropyl ether, and benzoin isobutyl ether; phosphines, such as 2,4,6-trimethylbenzoyl-diphenyl-phosphine oxide and bis(2,4,6-trimethylbenzoyl)-phenylphosphine oxide; and other examples such as methyl phenylglyoxylate.

Among the photoradical polymerization initiators, preferred are acetophenones represented by aminoketone, phosphines, and oxime ester compounds. They can be used alone or in combination depending on the properties desired for the cured product. The amount of the radical polymerization initiator to be used is preferably 0.01 to 100 parts by mass and more preferably 0.1 to 50 parts by mass based on 100 parts by mass of the total amount of the solid content in the composition.

### Other Additives

In the present embodiment, the photoresponsive composition may be used, as needed, by mixing with an oxygen remover, an antioxidant, a scattering agent such as titanium oxide, a surfactant, an antifungal agent, a light stabilizer, other additives that impart various properties, a diluting solvent, and so on.

### Second Embodiment

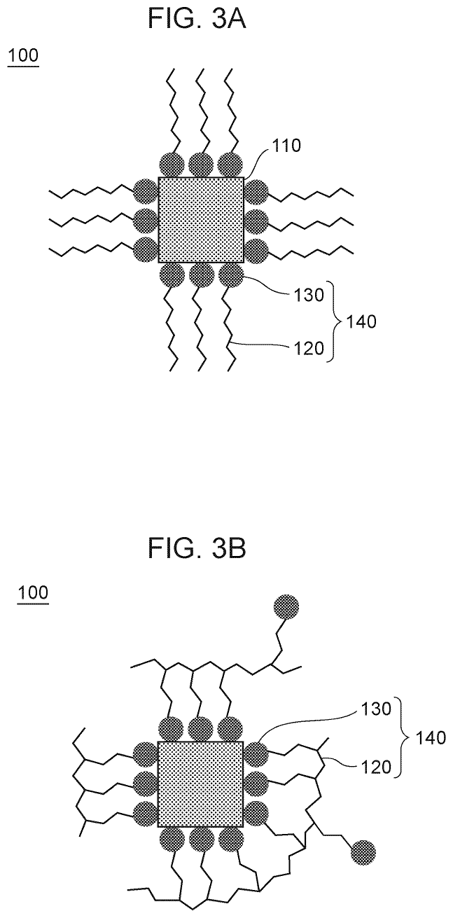

A nanoparticle composition 100 according to a second embodiment will be described using FIGS. 3A and 3B.

The nanoparticle composition 100 according to the second embodiment includes a nanoparticle 110 having a perovskite-type crystal structure as an allotrope and an associative ligand 140 including a main chain 120 having a plurality of carbon atoms and a polar group 130 having a higher polarity than the main chain. At least a portion of the associative ligand 140 coordinates to the nanoparticle 110 via the polar group 130 to change the crystal structure of the nanoparticle.

### Nanoparticle

The nanoparticle 110 in the present embodiment is a nanoparticle that includes, as an allotrope, a nanocrystal having a perovskite-type crystal structure in which an A-site (monovalent cation), a B-site (divalent cation), and an X-site (monovalent anion including a halide anion) are structural components. As the structural components, the same components as those of the nanoparticle P described in the first embodiment can be used.

### Associative Ligand

In the present embodiment, the associative ligand 140 includes a main chain 120 having a plurality of carbon atoms and a polar group 130 having a higher polarity than the main chain. In addition, the association ligand 140 coordinates to the nanoparticle 110 via the polar group 130 to change the crystal structure of the nanoparticle 110.

The associative ligand 140 may be made of a low molecular compound as is shown in FIG. 3A or may be made of a high molecular compound as is shown in FIG. 2B. Alternatively, both a low molecular compound and a high molecular compound may be included (not shown).

From the viewpoint of effectively inducing a change to the α-phase, it is preferable that the associative ligand 140 is mainly made of a high molecular compound.

The main chain 120 of the low molecular compound is a linear, branched, or cyclic alkyl group, a linear, branched, or cyclic heteroalkyl group, an aryl group, a heteroaryl group, an aralkyl group, or a heteroaralkyl group. These compounds may be further partially substituted.

The polar group 130 is at least one selected from the group consisting of a strong acid such as sulfonic acid and phosphonic acid, a strong base such as a quaternary ammonium cation, a zwitterion group such as sulfobetaine, phosphobetaine, and carboxybetaine, and salts and ions thereof.

As the high molecular compound, a copolymer obtained by polymerization of at least two types of monomers can be used.

### Third Embodiment

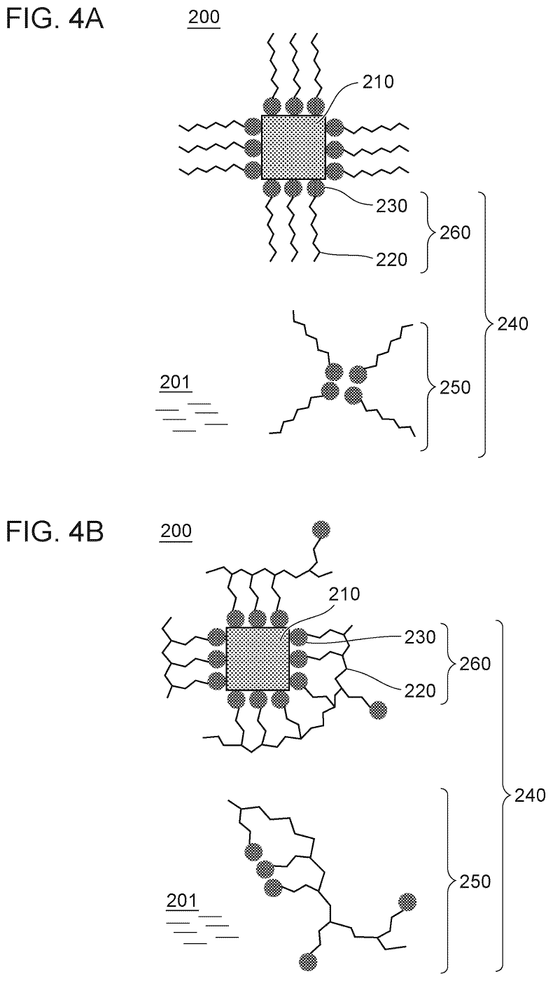

A nanoparticle composition according to a third embodiment will be described using FIGS. 4A and 4B.

The nanoparticle composition according to the third embodiment includes a solvent 201 having a relative dielectric constant of a prescribed value or less, a nanoparticle 210 having a perovskite-type crystal structure as an allotrope, and multiple ligands 240 each including a main chain 220 that has a plurality of carbon atoms and a polar group 230 that has a higher polarity than the main chain, wherein the multiple ligands 240 include a first component 250 that constitutes a reverse micelle-like structure in the solvent 201 and a second component 260 that coordinates to the surface of the nanoparticle.

The multiple ligands 240 may be made of a low molecular compound as is shown in FIG. 4A or may be made of a high molecular compound as is shown in FIG. 4B. Alternatively, both a low molecular compound and a high molecular compound may be included (not shown).

From the viewpoint of effectively inducing a change to the α-phase, it is preferable that the multiple ligands 240 are mainly made of a high molecular compound.

The main chain 220 of the low molecular compound is a linear, branched, or cyclic alkyl group, a linear, branched, or cyclic heteroalkyl group, an aryl group, a heteroaryl group, an aralkyl group, or a heteroaralkyl group. These compounds may be further partially substituted.

The polar group 230 is at least one selected from the group consisting of a strong acid such as sulfonic acid and phosphonic acid, a strong base such as a quaternary ammonium cation, a zwitterion group such as sulfobetaine, phosphobetaine, and carboxybetaine, and salts and ions thereof.

As the high molecular compound, a copolymer obtained by polymerization of at least two types of monomers can be used.

### Reverse Micelle-Like Structure

In the present embodiment, the reverse micelle-like structure is a structure made of polar groups 230 at least partially associated with each other by electrostatic interaction in the solvent 201 having a relative dielectric constant of a prescribed value or less. The polar groups 230 do not necessarily have to directly interact with each other, and a small amount of a polar substance such as water may intervene therebetween. In addition, the association may be intermolecular association or intramolecular association. Alternatively, different types of polar groups may associate with each other by electrostatic interaction.

### Fourth Embodiment

The nanoparticle compositions 100, 200 having fluidity effectively express the effect of the present invention of maintaining the α-phase even in a form in which the nanoparticle compositions 100, 200 are cured on a base material. The nanoparticle composition 200 (100) takes a layer form supported by another member and may be therefore rephrased as a wavelength conversion layer. In the support form, a laminated form and a dispersed form in which the composition is dispersed in a matrix material are included. Examples of the wavelength conversion layer include a film, a sheet, or a patterned pixel obtained by applying and curing the nanoparticle composition on a support member (base material).

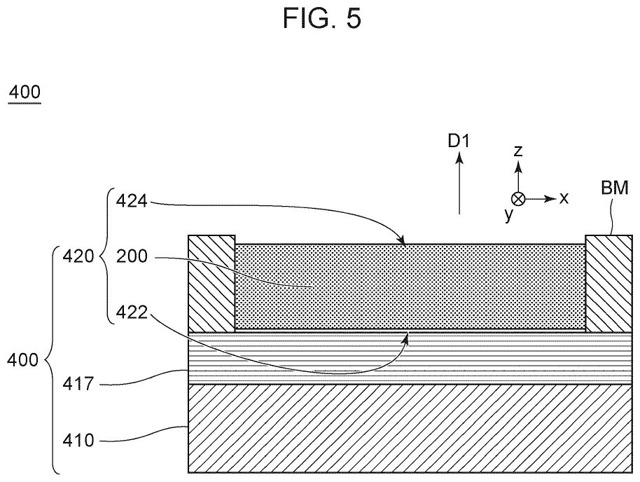

FIG. 5 shows a cross-sectional structure of a display device 400 according to the fourth embodiment.

In the display device 400, a light-emitting layer 410, a dielectric multilayer film 417, and a wavelength conversion layer 420 are stacked in the stacking direction D1. The downstream side in the stacking direction D1 corresponds to the side where a user is positioned to view the image drawn on the display device. The wavelength conversion layer 420 is divided from the wavelength conversion layer corresponding to the adjacent device by a black matrix BM that separates pixels.

The nanoparticle composition 200 is in a form of containing a polymerizable monomer (not shown) as described above. The nanoparticle composition 200 containing a polymerizable monomer is cured together with a polymerizable compound by polymerization such as photopolymerization. The nanoparticle composition 200 is cured and becomes a solid nanoparticle composition 426 supported by a dielectric multilayer film 417. The nanoparticle composition 426 is configured so as to satisfy a prescribed dimension and thereby configures the wavelength conversion layer 420 of the display device 400. That is, the wavelength conversion layer 420 is a layer solidified by curing the entire nanoparticle composition 200 together with the polymerizable compound 150.

The light-emitting layer 410 corresponds to a light source that emits light L1 with a first wavelength λ1. The wavelength conversion layer 420 includes an optical coupling face 422 that is optically coupled with the light-emitting layer 410 on the side of the light-emitting layer 410 and is provided with an extraction face 424 for extracting secondary light L2 converted by the wavelength conversion layer 420 on the opposite side of the light-emitting layer 410.

The wavelength conversion layer 420 of the present embodiment receives primary light L1 with a wavelength λ1 that penetrates through the dielectric multilayer film 417. The dielectric multilayer film 417 provides, to the display device 400, the spectral transmission characteristics of the primary light from the light-emitting layer 410 and the spectral reflectance characteristics of the secondary light L2 with a wavelength λ2 emitted at the wavelength conversion layer 420. The wavelength λ2 of the secondary light L2 is longer than the wavelength λ1 of the primary light L1.

The dielectric multilayer film 417 can be replaced by another optical member having optical transparency to the light with a first wavelength λ1 emitted by the light-emitting layer 410. An optical member (not shown) can be disposed on the front (the opposite side of the light-emitting layer 410) of the extraction face 424.

### Method for Forming Wavelength Conversion Layer

The method for forming the wavelength conversion layer 420 is not particularly limited, and examples thereof include a method by coating a nanoparticle composition on a base material and then curing the film through performing pre-drying as needed and further performing heating or active energy ray irradiation as needed. The thickness of the wavelength conversion layer 420 after curing is preferably 0.1 to 200 μm and more preferably 1 to 100 μm.

As the active energy ray in the active energy ray irradiation, an electromagnetic wave that decreases the fluidity and accelerates curing through polymerization, crosslinking, drying, or the like, such as heat rays, UV rays, visible light rays, near infrared rays, and electron beams, is appropriately selected. The light source for application of the active energy ray is preferably a light source having a main wavelength of light in a wavelength region of 100 to 450 nm. Examples of such a light source include a ultra-high pressure mercury lamp, a high pressure mercury lamp, a medium pressure mercury lamp, a mercury xenon lamp, a metal halide lamp, a high power metal halide lamp, a xenon lamp, a pulsed xenon lamp, a deuterium lamp, a fluorescent lamp, an ND-YAG triple wave laser, a HE-CD laser, a nitrogen laser, an XE-Cl excimer laser, an XE-F excimer laser, a semiconductor-pumped solid-state laser, and an LED lamp light source having an emission wavelength of 365 nm, 375 nm, 385 nm, 395 nm, or 405 nm.

### Measurement Method

Various physical properties can be measured as follows.

### Measurement of Molecular Weight Distribution

The molecular weight distribution of the high molecular compound can be calculated by gel permeation chromatography (GPC) in terms of monodisperse polymethyl methacrylate. The molecular weight can be measured by GPC, for example, as follows.

A sample is added to an eluent described below so as to give a sample concentration of 1 mass %, the mixture is left to stand at room temperature for 24 hours to prepare a solution, and the solution is filtered through a solvent-resistant membrane filter with a pore diameter of 0.45 μm to obtain a sample solution, which is subjected to measurement under the following conditions:
Apparatus: Agilent 1260 infinity system (manufactured by Agilent Technologies, Inc.);
Column: PFG analytical linear M columns (manufactured by Precision System Science Co., Ltd.);
Eluent: 2,2,2-trifluoroethanol;
Flow rate: 0.2 mL/min;
Oven temperature: 40° C.; and
Sample injection volume: 20 μL.

In the calculation of the molecular weight distribution of a sample, a molecular weight calibration curve produced by using a standard polymethyl methacrylate resin (manufactured by Agilent Technologies, Inc., EasiVial PM polymer standard kit) is used.

### Structure Analysis of Associative Ligand

The structure analysis of an associative ligand can be performed using nuclear magnetic resonance (NMR). For example, spectra of ¹H-NMR and ¹³C-NMR are measured using ECA-600 (600 MHz) manufactured by JEOL Ltd. On that occasion, the measurement is performed at 25° C. in a deuteration solvent including tetramethylsilane as an internal standard material. The chemical shift value is read as a ppm shift value (δ value) with tetramethylsilane as the internal standard material set as 0.

### Verification Method of Coordination of Associative Ligand to Nanoparticle

Whether the associative ligand 60 is coordinated to the nanoparticle P or not can be verified using nuclear magnetic resonance (NMR). For example, ¹H-NMR is measured using ECA-600 (600 MHz) manufactured by JEOL Ltd. Coordination can be confirmed by a shift of the δ value of the ¹H signal in the betaine structure from the δ value of the associative ligand alone or a change of the half width.

### Analysis of Association State of Associative Ligand

The association state of an associative ligand can be analyzed using NMR or dynamic light scattering (DLS). When NMR is used, for example, ¹H-NMR is measured using ECA-600 (600 MHz) manufactured by JEOL Ltd. When the ligand is associated, the chemical shift value of the signal of the polar group changes from the value in the unassociated state. In addition, when the ligand is associated, since the molecular movement is restricted, a spectrum that is broader overall is observed. As needed, it is also possible to analyze the association state in more detail by relaxation time measurement. When DLS is used, the association state can be analyzed from the particle diameter. When the associative ligand forms a larger structure by the intermolecular association, a particle diameter of an approximately several hundred nanometers is observed. In intramolecular association, a particle diameter of an approximately several nanometers is observed.

### Analysis of Crystal Structure (Crystalline Phase) of Nanoparticle

Crystal structure (crystalline phase) analysis and composition analysis of a nanoparticle can be performed using X-ray diffraction (XRD). For example, crystal structure and composition can be analyzed by measuring the X-ray diffraction pattern using RINT 2100 (manufactured by Rigaku Corporation) and comparing it with the diffraction pattern on a database. Depending on the form and size of the analysis specimen, electron beam diffraction (ED) accompanied cross-sectional TEM may be used.

### Verification Method of Single Phase Formation

Formation of a single-phase crystal structure (crystalline phase) of a nanoparticle can be verified from a change in the XRD signal. For example, in a nanoparticle having a γ-phase, two signals overlap at a diffraction angle (2θ) of around 30°, and therefore the half width is large, but the half width is decreased by changing the γ-phase to an α-phase.

### Composition Analysis of Nanoparticle

The composition of a nanoparticle can also be analyzed using XPS and ICP emission spectral analysis. The molar ratio of A and B can be measured from the signal strength of XPS, and the concentration of X can be measured from the emission intensity in ICP emission spectral analysis (e.g., CIROS CCD (manufactured by SPECTRO GmbH)).

### Amounts of Ligand and Associative Ligand Relative to Nanoparticle P

The amount of the ligand relative to the amount of the nanoparticle P can be determined by TG-DTA measurement and NMR measurement. For example, the amount of the nanoparticle P in a nanoparticle composition is measured by TG-DTA measurement. Subsequently, the amount of the ligand and the amount of the associative ligand in the nanoparticle composition are respectively determined by NMR measurement, and thereby the amounts of the ligand and the associative ligand relative to the nanoparticle P can be determined.

### Amount of Polar Group in Associative Ligand

The amount of a polar group in an associative ligand can be determined by NMR measurement. For example, ¹H-NMR is measured using ECA-600 (600 MHz) manufactured by JEOL Ltd. The amount of the polar group in the associative ligand is calculated by comparing the signal strength derived from the polar group and the signal strength derived from the portion other than the polar group.

### Millimolar Number of Polar Group Per 1 g of Nanoparticle

The millimolar number of the polar group per 1 g of the nanoparticle can be calculated from the amount of the nanoparticle P, the amount of the associative ligand, and the amount of the polar group in the associative ligand determined by the above methods.

### EXAMPLES

The present disclosure will be described in more detail by Examples below, but the present disclosure is not limited thereby.

### Manufacturing of Associative Ligand a

A reaction vessel equipped with a condenser tube, a stirrer, a thermometer, and a nitrogen inlet tube was provided. The reaction vessel was charged with 3-[[2-(methacryloyloxy)ethyl]dimethylammonio]propane-1-sulfonate (0.8 parts), hexyl methacrylate (51.1 parts), azobisisobutyronitrile (3.9 parts), and 2,2,2-trifluoroethanol (900 parts). Furthermore, the reaction vessel was subjected to nitrogen bubbling for 30 minutes. The resulting reaction mixture was heated at 65° C. for 8 hours under a nitrogen atmosphere to complete the polymerization reaction. The reaction solution was cooled to room temperature, and water (300 parts) was then added thereto to precipitate the product. After centrifugation, the supernatant was removed. The solvent was distilled off under reduced pressure, followed by drying at 50° C. under a reduced pressure of 0.1 kPa or less to obtain an associative ligand a. It was confirmed by NMR measurement that the structure unit including the polar group was contained in an amount of 1 mol % of the total monomer units. The weight-average molecular weight (Mw) by GPC analysis was 12500.

### Manufacturing of Associative Ligand b

An associative ligand b was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 5.9 parts and from 51.1 parts to 48.0 parts, respectively.

### Manufacturing of Associative Ligand c

An associative ligand c was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 6.8 parts and from 51.1 parts to 47.5 parts, respectively.

### Manufacturing of Associative Ligand d

An associative ligand d was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 10.2 parts and from 51.1 parts to 45.4 parts, respectively.

### Manufacturing of Associative Ligand e

An associative ligand e was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 15.2 parts and from 51.1 parts to 42.3 parts, respectively.

### Manufacturing of Associative Ligand f

An associative ligand f was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 20.3 parts and from 51.1 parts to 39.2 parts, respectively.

### Manufacturing of Associative Ligand g

An associative ligand g was manufactured as in the manufacturing of the associative ligand a except that the amounts of 3-[[2-(methacryloyloxy)ethyl]dimethylammonio]propane-1-sulfonate and hexyl methacrylate in the manufacturing of the associative ligand a were changed from 0.8 parts to 33.9 parts and from 51.1 parts to 31.0 parts, respectively.

### Manufacturing of Associative Ligand h

An associative ligand h was manufactured as in the manufacturing of the associative ligand a except that 0.8 parts of 3-[[2-(methacryloyloxy)ethyl]dimethylammonio]propane-1-sulfonate in the manufacturing of the associative ligand a was changed to 10.7 parts of 2-(methacryloyloxy)ethyl-2-(trimethylammonio)ethyl phosphate and the amount of hexyl methacrylate was changed from 51.1 parts to 45.4 parts.

### Manufacturing of Associative Ligand i

An associative ligand i was manufactured as in the manufacturing of the associative ligand a except that 0.8 parts of 3-[[2-(methacryloyloxy)ethyl]dimethylammonio]propane-1-sulfonate in the manufacturing of the associative ligand a was changed to 7.8 parts of 2-[[2-(methacryloyloxy)ethyl]dimethylammonio]acetate and the amount of hexyl methacrylate was changed from 51.1 parts to 45.4 parts.

### Manufacturing of Associative Ligand j

A reaction vessel equipped with a condenser tube, a stirrer, a thermometer, and a nitrogen inlet tube was charged with [2-(methacryloyloxy)ethyl]trimethylammonium chloride (80% aqueous solution, 7.6 parts), hexyl methacrylate (45.4 parts), azobisisobutyronitrile (3.9 parts), and n-butanol (900 part), followed by nitrogen bubbling for 30 minutes. The resulting reaction mixture was heated at 65° C. for 8 hours under a nitrogen atmosphere to complete the polymerization reaction. The reaction solution was cooled to room temperature, and water (300 parts) was then added thereto to precipitate the product. After centrifugation, the supernatant was removed. The solvent was distilled off under reduced pressure, followed by drying at 50° C. under a reduced pressure of 0.1 kPa or less. The resulting solid (5 parts) was dissolved in tetrahydrofuran (95 parts), and a solution obtained by dissolving sodium bromide (1.3 parts) in water (2.7 parts) was gradually added thereto, followed by stirring for 2 hours at room temperature. The resulting solution was reprecipitated with water, washed with methanol, and then vacuum-dried at 50° C. for 6 hours to manufacture an associative ligand j.

### Manufacturing of Associative Ligand k

An associative ligand k was manufactured as in the manufacturing of the associative ligand a except that 0.8 parts of 3-[[2-(methacryloyloxy)ethyl]dimethylammonio]propane-1-sulfonate in the manufacturing of the associative ligand a was changed to 3.1 parts of methacrylic acid and the amount of hexyl methacrylate was changed from 51.1 parts to 45.4 parts.

### Preparation of Associative Ligand l

As an associative ligand l, octadecyldimethyl(3-sulfopropyl)ammonium Hydroxide inner salt (manufactured by Tokyo Chemical Industry Co., Ltd.) was provided.

Table 1 shows the structures, compositions, and molecular weights of the manufactured or provided associative ligands a to k.

TABLE 1

| | | | Molec- |
|---|---|---|---|
| | | | ular |
| | Structure | m:n | weight |
| Asso- | | | |
| ciative | | | |
| ligand | | | |
| a | 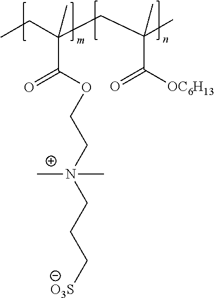 | 1:99 | 12500 |
| b | 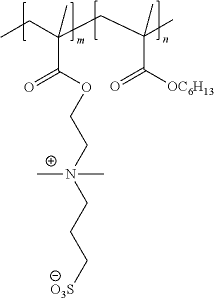 | 7:93 | 13200 |
| c | 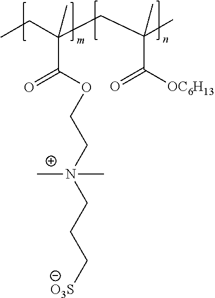 | 8:92 | 13000 |
| d | 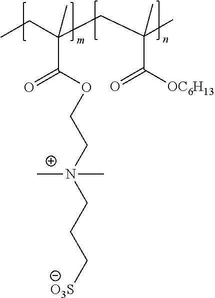 | 12:88 | 12400 |
| e | 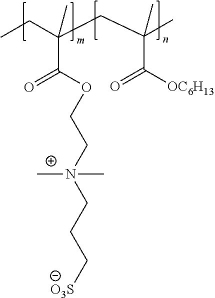 | 18:82 | 13500 |
| f | 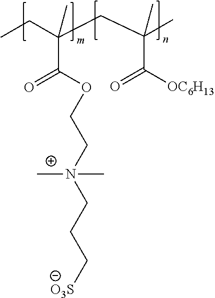 | 24:76 | 13800 |
| Asso- | | | |
| ciative | | | |
| ligand | | | |
| Nd | | | |
| g | 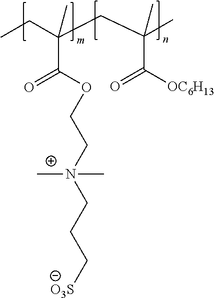 | 40:60 | 15400 |
| h | 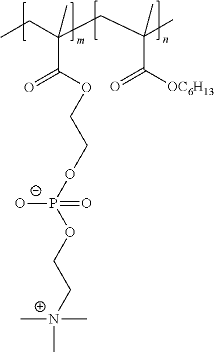 | 12:88 | 13700 |
| i | 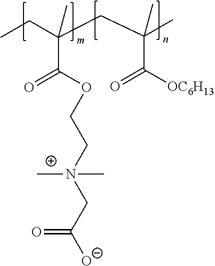 | 12:88 | 11900 |
| j | 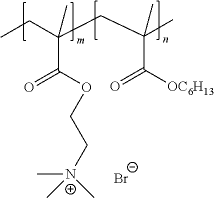 | 12:88 | 11500 |
| k | 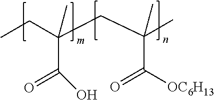 | 12:88 | 11000 |
| l | 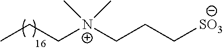 | — | 420 |

### Preparation of Associated Solution

### Associated Solution of Associative Ligand a in Toluene

A reaction vessel equipped with a stirrer, a thermometer, and a reflux condenser was charged with the associative ligand a (1 part) and toluene (99 parts), and the temperature thereof was increased to 110° C., and the temperature was maintained for 5 minutes. After confirmation that the associative ligand a was completely dissolved, the solution was cooled to room temperature to obtain an associated solution a of the associative ligand a in toluene.

### Associated Solutions of Associative Ligands b to l in Toluene

Associated solutions b to l of high molecular compounds b to l in toluene were prepared as in the associated solution of associative ligand a in toluene except that the associative ligands b to l were used instead of the associative ligand a.

### Associated Solution of Associative Ligand d in Hexane

A reaction vessel equipped with a stirrer, a thermometer, and a reflux condenser was charged with the associative ligand d (1 part) and hexane (99 parts), and the temperature thereof was increased to 60° C., and the temperature was maintained for 5 minutes. The solution was cooled to room temperature to obtain an associated solution d-2 of the associative ligand d in hexane.

### Associated Solution of Associative Ligand d in Chloroform

A reaction vessel equipped with a stirrer, a thermometer, and a reflux condenser was charged with the associative ligand d (1 part) and chloroform (99 parts), and the temperature thereof was increased to 60° C., and the temperature was maintained for 5 minutes. The solution was cooled to room temperature to obtain an associated solution d-3 of the associative ligand d in chloroform.

### Associated Solution of Associative Ligand d in Ethyl Acetate

A reaction vessel equipped with a stirrer, a thermometer, and a reflux condenser was charged with the associative ligand d (1 part) and ethyl acetate (99 parts), and the temperature thereof was increased to 70° C., and the temperature was maintained for 5 minutes. The solution was cooled to room temperature to obtain an associated solution d-4 of the associative ligand d in ethyl acetate.

### Manufacturing of Nanoparticle P-1

Cesium carbonate (10 parts), oleic acid (27 parts), and 1-octadecene (385 parts) were placed in a flask, and the solution temperature was increased to 120° C., followed by deaeration with a vacuum pump for 30 minutes. Furthermore, the solution temperature was increased to 150° C. under a dry nitrogen gas flow, and the temperature was maintained for 30 minutes to obtain a cation raw material solution.

Separately, lead(II) bromide (10 parts) and 1-octadecene (494 parts) were placed in a flask, and the solution temperature was increased to 120° C., followed by deaeration with a vacuum pump for 1 hour. Oleic acid (89 parts) and oleylamine (31 parts) were added thereto, followed by further deaeration with a vacuum pump for 30 minutes. Then, the solution temperature was set to 185° C. instead of the nitrogen flow.

The cation raw material solution (40 parts) was added thereto, and after 5 seconds, the mixture was cooled on ice. Ethyl acetate (2000 parts) was added thereto, centrifugation was performed, and the supernatant was removed. The resulting residue was dispersed in toluene, and the solid concentration was adjusted to 1 wt % to obtain a dispersion a of a nanoparticle P-1 having a perovskite-type crystal structure of CsPbBr₃. The ratio of the nanoparticle P in the solid content measured by TG-DTA was 53 wt %. When XRD was measured, a signal derived from the γ-phase of CsPbBr₃ and a signal derived from CsPb₂Br₅ were observed.

### Manufacturing of Nanoparticle P-2

A dispersion of the nanoparticle P-2 having a perovskite-type crystal structure of CsPb(Br/I)₃ was obtained as in the light-emitting nanocrystal dispersion a except that lead(II) bromide (3.2 parts) and lead(II) iodide (9.3 parts) were used instead of lead(II) bromide (10 parts). The ratio of the nanoparticle P in the solid content measured by TG-DTA was 52 wt %. When XRD was measured, a signal derived from the γ-phase of CsPbBr₃ was observed.

### Manufacturing of Nanoparticle P-3

A nanoparticle P-3 having a perovskite-type crystal structure of CsPbBr₃ was manufactured as in the nanoparticle P-1 except that the solution temperature in the manufacturing of the nanoparticle P-1 was changed to 220° C. The ratio of the nanoparticle P in the solid content measured by TG-DTA was 55 wt %. When XRD was measured, signals derived from the α-phase and the γ-phase of CsPbBr₃ were observed.

### Example 1

The dispersion a (100 parts) of the nanoparticle P-1 was placed in a container, and the solvent was distilled off under reduced pressure. The associated solution a (100 parts) of the associative ligand a in toluene was added to the container, ultrasonication was performed for 20 minutes to promote the coordination and the change in the crystalline phase to obtain a nanoparticle composition 100-1.

### Examples 2 to 16 and Comparative Examples 1 to 4

Nanoparticle Compositions 100-2 to 20 were obtained as in EXAMPLE 1 except that the types of the nanoparticle P, the associative ligand, and the associated solution were changed to those shown in Table 2.

TABLE 2

| | | | | Millimolar | |
|---|---|---|---|---|---|
| | Nanoparticle | | | number of polar | |
| | composition | | Associative | group per 1 g of | Associated |
| | 100 | Nanoparticle P | solution | nanoparticle P | liquid |
| Example 1 | Nanoparticle | Nanoparticle P-1 | Associative | 0.1 | Associated |
| | composition | | solution a | | liquid a |
| | 100-1 | | | | |
| Example 2 | Nanoparticle | Nanoparticle P-1 | Associative | 0.8 | Associated |
| | composition | | solution b | | liquid b |
| | 100-2 | | | | |
| Example 3 | Nanoparticle | Nanoparticle P-1 | Associative | 0.9 | Associated |
| | composition | | solution c | | liquid c |
| | 100-3 | | | | |
| Example 4 | Nanoparticle | Nanoparticle P-1 | Associative | 1.3 | Associated |
| | composition | | solution d | | liquid d |
| | 100-4 | | | | |
| Example 5 | Nanoparticle | Nanoparticle P-1 | Associative | 1.8 | Associated |
| | composition | | solution e | | liquid e |
| | 100-5 | | | | |
| Example 6 | Nanoparticle | Nanoparticle P-1 | Associative | 2.3 | Associated |
| | composition | | solution f | | liquid f |
| | 100-6 | | | | |
| Example 7 | Nanoparticle | Nanoparticle P-1 | Associative | 3.6 | Associated |
| | composition | | solution g | | liquid g |
| | 100-7 | | | | |
| Example 8 | Nanoparticle | Nanoparticle P-1 | Associative | 1.2 | Associated |
| | composition | | solution h | | liquid h |
| | 100-8 | | | | |
| Example 9 | Nanoparticle | Nanoparticle P-1 | Associative | 1.3 | Associated |
| | composition | | solution i | | liquid i |
| | 100-9 | | | | |
| Example 10 | Nanoparticle | Nanoparticle P-1 | Associative | 1.3 | Associated |
| | composition | | solution j | | liquid j |
| | 100-10 | | | | |
| Example 11 | Nanoparticle | Nanoparticle P-1 | Associative | 1.4 | Associated |
| | composition | | solution k | | liquid k |
| | 100-11 | | | | |
| Example 12 | Nanoparticle | Nanoparticle P-1 | Associative | 1.3 | Associated |
| | composition | | solution d | | liquid d-2 |
| | 100-12 | | | | |
| Example 13 | Nanoparticle | Nanoparticle P-1 | Associative | 1.3 | Associated |
| | composition | | solution d | | liquid d-3 |
| | 100-13 | | | | |
| Example 14 | Nanoparticle | Nanoparticle P-1 | Associative | 1.3 | Associated |
| | composition | | solution d | | liquid d-4 |
| | 100-14 | | | | |
| Example 15 | Nanoparticle | Nanoparticle P-2 | Associative | 1.3 | Associated |
| | composition | | solution d | | liquid d |
| | 100-15 | | | | |
| Example 16 | Nanoparticle | Nanoparticle P-1 | Associative | 4.6 | Associated |
| | composition | | solution I | | liquid 1 |
| | 100-16 | | | | |
| Comparative | Nanoparticle | Nanoparticle P-1 | — | — | Toluene |
| Example 1 | composition | | | | |
| | 100-17 | | | | |
| Comparative | Nanoparticle | Nanoparticle P-1 | — | — | Toluene |
| Example 2 | composition | | | | |
| | 100-18 | | | | |
| Comparative | Nanoparticle | Nanoparticle P-2 | — | — | Toluene |
| Example 3 | composition | | | | |
| | 100-19 | | | | |
| Comparative | Nanoparticle | Nanoparticle P-3 | — | — | Toluene |
| Example 4 | composition | | | | |
| | 100-20 | | | | |

### Evaluation

Evaluation of Crystalline Phase Immediately after Treatment

Each solution (50 μL) immediately after the treatment was placed in a sample holder, the solvent was removed, and XRD was measured. When the nanoparticle P-1 was used, the half width of a signal having the maximum in a diffraction angle (2θ) range of 30° to 31° was measured, and when the nanoparticle P-2 was used, the half width of a signal having the maximum in a diffraction angle (2θ) range of 28° to 30° was measured. The evaluation criteria are shown below.

### Evaluation Criteria:

A: a half width of 0.85° or less;
B: a half width of lager than 0.85° and 0.9° or less;
C: a half width of larger than 0.9° and 0.980 or less; and
D: a half width of larger than 0.98°.
   Evaluation of Crystalline Phase after the Lapse of Time

The sample holder after the evaluation of crystalline phase immediately after the treatment was left to stand in a draft for 1 week, and then XRD was measured again. When the nanoparticle P-1 was used, the half width of a signal having the maximum in a diffraction angle (2θ) range of 30° to 31° was measured, and when the nanoparticle P-2 was used, the half width of a signal having the maximum in a diffraction angle (2θ) range of 28° to 30° was measured. The evaluation criteria are shown below.

### Evaluation Criteria:

A: a half width of 0.85° or less;
B: a half width of lager than 0.85° and 0.9° or less;
C: a half width of larger than 0.9° and 0.98° or less; and
D: a half width of larger than 0.98°.

Table 3 shows the evaluation results.

TABLE 3

| | | Evaluation of | Evaluation of |
|---|---|---|---|
| | | crystalline | crystalline |
| | Nanoparticle | phase immediately | phase after the |
| | composition 100 | after treatment | lapse of time |
| Example 1 | Nanoparticle | C | B |
| | composition 100-1 | | |
| Example 2 | Nanoparticle | B | A |
| | composition 100-2 | | |
| Example 3 | Nanoparticle | A | A |
| | composition 100-3 | | |
| Example 4 | Nanoparticle | A | A |
| | composition 100-4 | | |
| Example 5 | Nanoparticle | A | A |
| | composition 100-5 | | |
| Example 6 | Nanoparticle | A | A |
| | composition 100-6 | | |
| Example 7 | Nanoparticle | B | A |
| | composition 100-7 | | |
| Example 8 | Nanoparticle | A | A |
| | composition 100-8 | | |
| Example 9 | Nanoparticle | A | A |
| | composition 100-9 | | |
| Example 10 | Nanoparticle | B | B |
| | composition 100-10 | | |
| Example 11 | Nanoparticle | B | B |
| | composition 100-11 | | |
| Example 12 | Nanoparticle | B | A |
| | composition 100-12 | | |
| Example 13 | Nanoparticle | B | C |
| | composition 100-13 | | |
| Example 14 | Nanoparticle | C | C |
| | composition 100-14 | | |
| Example 15 | Nanoparticle | A | A |
| | composition 100-15 | | |
| Example 16 | Nanoparticle | C | B |
| | composition 100-16 | | |
| Comparative | Nanoparticle | D | D |
| Example 1 | composition 100-17 | | |
| Comparative | Nanoparticle | D | D |
| Example 2 | composition 100-18 | | |
| Comparative | Nanoparticle | D | D |
| Example 3 | composition 100-19 | | |
| Comparative | Nanoparticle | B | D |
| Example 4 | composition 100-20 | | |

According to Table 3, in the nanoparticle compositions 100-1 to 16 according to EXAMPLES 1 to 16, the crystalline phase immediately after the treatment was formed into a single phase, compared to the nanoparticle compositions 100-17 to 19 according to COMPARATIVE EXAMPLES 1 to 3. In addition, the resulting single crystalline phase was maintained even after the lapse of time. These results are believed to be due to the formation of the crystalline phase into a single phase through coordination of the associative ligand 60 to the nanoparticle P having a perovskite-type structure in the low polar solvent 10. In the nanoparticle composition 20 containing the nanoparticle P-3 synthesized at high temperature, the crystalline phase immediately after the treatment includes an α-phase, but the α-phase cannot be maintained over time.

The present invention is not limited to the above embodiments, and various modifications and variations can be made without departing from the spirit and scope of the present invention. Accordingly, to apprise the public of the scope of the present invention, the following claims are appended.

According to the present invention, it is possible to provide a method of purifying a nanoparticle that can obtain an α-phase at a lower temperature condition. In addition, according to the present invention, it is possible to provide a nanoparticle composition that can maintain the α-phase even over time.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A method for purifying a nanoparticle, comprising:
a step of preparing a nanoparticle that has a perovskite-type crystal structure as an allotrope and includes multiple crystal structures;
a step of preparing a ligand solution containing a solvent that has a relative dielectric constant of a prescribed value or less and an associative ligand that includes a main chain having a plurality of carbon atoms and a polar group having a higher polarity than the main chain and self-associates in the solvent; and
a step of preparing a nanoparticle dispersion by bringing the nanoparticle and the ligand solution into contact with each other, wherein
the step of preparing the nanoparticle dispersion includes a step of selectively increasing a ratio of the content of a prescribed crystal structure in the multiple crystal structures.

2. The method for purifying a nanoparticle according to claim 1, wherein the step of selectively increasing the ratio of the content of a prescribed crystal structure in the multiple crystal structures includes a step of making the crystal structure of the nanoparticle single phase.

3. The method for purifying a nanoparticle according to claim 1, wherein the step of selectively increasing the ratio of the content of a prescribed crystal structure in the multiple crystal structures includes a step of alternatively increasing a ratio of the content of a prescribed crystal structure in the multiple crystal structures.

4. The method for purifying a nanoparticle according to claim 2, wherein
the multiple crystal structures include at least any of an α-phase, a β-phase, and a γ-phase, and
the prescribed crystal structure includes an α-phase.

5. The method for purifying a nanoparticle according to claim 2, wherein
the multiple crystal structures include multiple crystal structures of which the synthesis temperatures are different from each other, and
the prescribed crystal structure corresponds to a crystal structure having the highest synthesis temperature among the multiple crystal structures.

6. The method for purifying a nanoparticle according to claim 1, comprising:
a first acquisition step of collecting a first solid content from the nanoparticle and acquiring information on the crystal structure of the first solid content; and
a second acquisition step of collecting a second solid content from the nanoparticle dispersion and acquiring information on the crystal structure of the second solid content.

7. The method for purifying a nanoparticle according to claim 6, comprising a step of verifying a change in the crystal structure of the nanoparticle by the step of preparing the nanoparticle dispersion, based on the information on the crystal structure of the first solid content and the information on the crystal structure of the second solid content.

8. The method for purifying a nanoparticle according to claim 1, wherein the polar group includes at least one selected from the group consisting of a strong acid, a strong base, a zwitterion group, and salts and ions thereof.

9. The method for purifying a nanoparticle according to claim 1, wherein the polar group includes at least one selected from the group consisting of sulfonic acid, phosphonic acid, quaternary ammonium cation, sulfobetaine, phosphobetaine, and carboxybetaine.

10. A method for manufacturing a nanoparticle composition, comprising:
a step of preparing a nanoparticle that has a perovskite-type crystal structure as an allotrope and includes multiple crystal structures;
a step of preparing a ligand solution containing a solvent that has a relative dielectric constant of a prescribed value or less and an associative ligand that includes a main chain having a plurality of carbon atoms and a polar group having a higher polarity than the main chain and self-associates in the solvent; and
a step of preparing a nanoparticle dispersion by bringing the nanoparticle and the ligand solution into contact with each other, wherein
the step of preparing the nanoparticle dispersion includes a step of selectively increasing a ratio of the content of a prescribed crystal structure in the multiple crystal structures.

11. The method for manufacturing a nanoparticle composition according to claim 10, comprising a step of adding a polymerizable compound to the nanoparticle dispersion.

12. A nanoparticle composition comprising:
a nanoparticle having a perovskite-type crystal structure as an allotrope; and
an associative ligand including a main chain having a plurality of carbon atoms and a polar group having a higher polarity than the main chain, wherein
at least a portion of the associative ligand coordinates to the nanoparticle via the polar group to change the crystal structure of the nanoparticle.

13. A nanoparticle composition comprising:
a solvent having a relative dielectric constant of a prescribed value or less;
a nanoparticle having a perovskite-type crystal structure as an allotrope;
multiple ligands each including a main chain having a plurality of carbon atoms and a polar group having a higher polarity than the main chain, wherein the multiple ligands include:
a first component that constitutes a reverse micelle-like structure in the solvent; and
a second component that coordinates to the surface of the nanoparticle.
